(19) United States
(12) Patent Application Publication
(10) Pub. No.: US 2025/0168370 A1
(43) Pub. Date: May 22, 2025

(54) NEURAL NETWORK-BASED ADAPTIVE IMAGE AND VIDEO COMPRESSION METHOD

(71) Applicant: Bytedance Inc., Los Angeles, CA (US)

(72) Inventors: Semih Esenlik, San Diego, CA (US); Zhaobin Zhang, San Diego, CA (US); Kai Zhang, San Diego, CA (US); Li Zhang, San Diego, CA (US)

(21) Appl. No.: 19/033,178

(22) Filed: Jan. 21, 2025

Related U.S. Application Data
(63) Continuation of application No. PCT/US2023/028059, filed on Jul. 18, 2023.
(60) Provisional application No. 63/390,263, filed on Jul. 18, 2022.

(51) Int. Cl. H04N 19/192; H04N 19/124; H04N 19/70

(52) U.S. Cl. CPC H04N 19/192; H04N 19/124; H04N 19/70

(57) ABSTRACT

An image decoding method including transforming an input image into latent samples using an analysis transform; quantizing the latent samples using a hyper encoder to generate quantized hyper latent samples; encoding the quantized hyper latent samples into a bitstream using entropy encoding; applying a latent sample prediction process to obtain quantized latent samples and quantized residual latent samples based on the latent samples using the quantized hyper latent samples; obtaining prediction samples following the latent sample prediction process; and entropy encoding the quantized hyper latent samples and the quantized residual latent samples into the bitstream.

### CROSS-REFERENCE TO RELATED PATENT APPLICATIONS

This application is a continuation of International Patent Application No. PCT/US2023/028059 filed on Jul. 18, 2023, which claims the priority to and benefits of U.S. Provisional Patent Application No. 63/390,263, filed on Jul. 18, 2022. All the aforementioned patent applications are hereby incorporated by reference in their entireties.

### TECHNICAL FIELD

This patent application relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

The disclosed aspects/embodiments provide techniques related to a neural network-based adaptive image and video compression method. The present disclosure targets the out of memory issue when the image or video sequence is too large to fit in the memory in the decoding process, therefore leading to fail of decoding. The disclosure provides a tiled partitioning scheme that offers the feasibility of successful decoding from the bitstreams irrespective of the spatial size, especially beneficial for a limited memory budge or for the large resolution images/videos.

A first aspect relates to an image decoding method, comprising: performing an entropy decoding process to obtain quantized hyper latent samples \hat{z} and quantized residual latent samples ŵ; applying a latent sample prediction process to obtain quantized latent samples ŷ from the quantized hyper latent samples \hat{z} and the quantized residual latent samples ŵ; and applying a synthesis transformation process to generate reconstructed image using the quantized latent samples ŷ.

Optionally, in any of the preceding aspects, another implementation of the aspect provides receiving a bitstream including a header, wherein the header comprises a model identifier (model_id), a metric specifying models used in the conversion, and/or a quality specifying a pretrained model quality.

Optionally, in any of the preceding aspects, another implementation of the aspect provides that the header specifies a height of a output picture in a number of luma samples (original_size_h) and/or a width of the output picture in a number of luma samples (original_size_w).

Optionally, in any of the preceding aspects, another implementation of the aspect provides the header specifies a height of a reconstructed picture in a number of luma samples after a synthesis transform and before a resampling process (resized_size_h) and/or a width of the reconstructed picture in a number of luma samples after the synthesis transform and before the resampling process (resized_size_w).

Optionally, in any of the preceding aspects, another implementation of the aspect provides that the header specifies a height of a quantized residual latent (latent_code_shape_h) and/or a width of the quantized residual latent (latent_code_shape_w).

Optionally, in any of the preceding aspects, another implementation of the aspect provides that the header specifies an output bit depth of an output reconstructed picture (output_bit_depth) and/or a number of bits needed to be shifted in obtaining the output reconstructed picture (output_bit_shift).

Optionally, in any of the preceding aspects, another implementation of the aspect provides that the header specifies a double precision processing flag specifying whether to enable double precision processing (double_precision_processing_flag).

Optionally, in any of the preceding aspects, another implementation of the aspect provides that the header specifies whether to apply deterministic processing in performing of the conversion between the visual media data and bitstream.

Optionally, in any of the preceding aspects, another implementation of the aspect provides that the header specifies a fast resize flag specifying whether to use fast resizing (fast_resize_flag).

Optionally, in any of the preceding aspects, another implementation of the aspect provides that the resampling process is performed according to the fast resize flag.

Optionally, in any of the preceding aspects, another implementation of the aspect provides that the header specifies a number to specify number of tiles (num_second_level_tile or num_first_level_tile).

Optionally, in any of the preceding aspects, another implementation of the aspect provides that the said number specifies a first level tile (num_first_level_tile) and/or a second level tiles (num_second_level_tile).

Optionally, in any of the preceding aspects, another implementation of the aspect provides that a synthesis transform or part of a synthesis transform is performed according to the number of tiles.

Optionally, in any of the preceding aspects, another implementation of the aspect provides that the header specifies a number of threads used in wavefront processing (num_wavefront_max or num_wavefront_min).

Optionally, in any of the preceding aspects, another implementation of the aspect provides that the header specifies a maximum number of threads used in wavefront processing (num_wavefront_max) and/or a minimum number of threads used in wavefront processing (num_wavefront_min).

Optionally, in any of the preceding aspects, another implementation of the aspect provides that the header specifies a number of samples shifted in each row compared to a preceding row of samples (waveshift).

Optionally, in any of the preceding aspects, another implementation of the aspect provides that a header specifies a number of parameter sets or filters used in an adaptive quantization process to control quantization of residuals.

Optionally, in any of the preceding aspects, another implementation of the aspect provides that a header includes a parameter that specifies how many times an adaptive quantization process is performed.

Optionally, in any of the preceding aspects, another implementation of the aspect provides that the adaptive quantization process is a process that modifies residual samples (ŵ) and/or variance samples (σ).

Optionally, in any of the preceding aspects, another implementation of the aspect provides that the header specifies a number of filters or parameter sets used in a residual sample skipping process.

Optionally, in any of the preceding aspects, another implementation of the aspect provides that the header specifies a number of parameter sets used in a latent domain masking and scaling to determine scaling at a decoder after the quantized latent samples (ŷ) are reconstructed.

Optionally, in any of the preceding aspects, another implementation of the aspect provides that the header specifies a number of parameter sets used in a latent domain masking and scaling to modify the quantized latent samples (ŷ) before application of a synthesis transform.

Optionally, in any of the preceding aspects, another implementation of the aspect provides that the header specifies whether a thresholding operation is to be applied as greater than or smaller than a threshold in the adaptive quantization process.

Optionally, in any of the preceding aspects, another implementation of the aspect provides that the header specifies a value of a multiplier to be used in the adaptive quantization process or a sample skipping process or a latent scaling before synthesis process.

Optionally, in any of the preceding aspects, another implementation of the aspect provides that the header specifies a value of a threshold to be used in the adaptive quantization process or a sample skipping process or a latent scaling before synthesis process.

Optionally, in any of the preceding aspects, another implementation of the aspect provides that the header includes a parameter that specifies number of the number of multipliers, thresholds or greater than flags that are specified in the header.

Optionally, in any of the preceding aspects, another implementation of the aspect provides that the header specifies a number of parameter sets, wherein a parameter set comprise a threshold parameter and a multiplier parameter.

Optionally, in any of the preceding aspects, another implementation of the aspect provides that the header includes an adaptive offset enabled flag that specifies whether adaptive offset is used.

Optionally, in any of the preceding aspects, another implementation of the aspect provides that the header specifies a number of horizontal splits in an adaptive offsetting process (num_horizontal_split) and a number of vertical splits in the adaptive quantization process (num_vertical_split).

Optionally, in any of the preceding aspects, another implementation of the aspect provides that the header specifies an offset precision (offsetPrecision), and wherein a number of adaptive offset coefficients are multiplied with the offset precision and rounded to a closest integer before being encoded.

Optionally, in any of the preceding aspects, another implementation of the aspect provides that the header specifies an offset precision (offsetPrecision), and wherein an adaptive offset coefficient is modified according to the offset precision.

Optionally, in any of the preceding aspects, another implementation of the aspect provides performing an entropy decoding process that comprises parsing two independent bitstreams, and wherein a first of the two independent bitstreams is decoded using a fixed probability density model.

Optionally, in any of the preceding aspects, another implementation of the aspect provides parsing the quantized hyper latent samples \hat{z} using a discretized cumulative distribution function, and processing the quantized hyper latent samples \hat{z} using a hyper scale decoder, which is a neural network (NN)-based subnetwork used to generate gaussian variances σ.

Optionally, in any of the preceding aspects, another implementation of the aspect provides applying arithmetic decoding on a second of the two independent bitstreams to obtain the quantized residual latent samples ŵ, and assuming zero-mean gaussian distribution [symbol] (0, σ²).

Optionally, in any of the preceding aspects, another implementation of the aspect provides performing an inverse transform operation on the quantized hyper latent samples \hat{z}, and wherein the inverse transform operation is performed by the hyper scale decoder.

Optionally, in any of the preceding aspects, another implementation of the aspect provides that an output of the inverse transform operation is concatenated with an output of a context model module to generate a concatenated output, wherein the concatenated output is processed by a prediction fusion model to generate prediction samples μ, and wherein the prediction samples are added to the quantized residual latent samples ŵ to obtain the quantized latent samples ŷ.

Optionally, in any of the preceding aspects, another implementation of the aspect provides that the the latent sample prediction process is an auto-regressive process.

Optionally, in any of the preceding aspects, another implementation of the aspect provides that the quantized latent samples ŷ[:,i,j] in different rows are processed in parallel.

Optionally, in any of the preceding aspects, another implementation of the aspect provides rounding an output of a hyper encoder.

Optionally, in any of the preceding aspects, another implementation of the aspect provides that the quantized residual latent samples ŵ are entropy encoded using gaussian variance variables σ obtained as output of a hyper scale decoder.

Optionally, in any of the preceding aspects, another implementation of the aspect provides that encoder configuration parameters are pre-optimized.

Optionally, in any of the preceding aspects, another implementation of the aspect provides that the method is implemented by an encoder, and wherein a prepare_weights() function of the encoder is configured to calculate default pre-optimized encoder configuration parameters.

Optionally, in any of the preceding aspects, another implementation of the aspect provides that a write_weights() function of the encoder includes the default pre-optimized encoder configuration parameters in high level syntax of the bitstream.

Optionally, in any of the preceding aspects, another implementation of the aspect provides that a rate distortion optimization process is not performed.

Optionally, in any of the preceding aspects, another implementation of the aspect provides that a decoding process is not performed as part of an encoding method.

Optionally, in any of the preceding aspects, another implementation of the aspect provides using a neural network-based adaptive image and video compression as disclosed herein.

A second aspect relates to an apparatus for processing video data comprising: a processor; and a non-transitory memory with instructions thereon, wherein the instructions upon execution by the processor, cause the processor to perform any of the disclosed methods.

A third aspect relates to a non-transitory computer readable medium comprising a computer program product for use by a video coding device, the computer program product comprising computer executable instructions stored on the non-transitory computer readable medium such that when executed by a processor cause the video coding device to perform any of the disclosed methods.

A fourth aspect relates to a non-transitory computer-readable recording medium storing a bitstream of a video which is generated by a method performed by a video processing apparatus, wherein the method comprises any of the disclosed methods.

A fifth aspect relates to a method for storing bitstream of a video comprising the method of any of the disclosed embodiments.

A sixth aspect relates to a method, apparatus, or system described in the present document.

A seventh aspect relates to an image decoding method, comprising: performing an entropy decoding process to obtain quantized hyper latent samples \hat{z} and quantized residual latent samples ŵ; applying a latent sample prediction process to obtain quantized latent samples ŷ from the quantized hyper latent samples \hat{z} and the quantized residual latent samples ŵ; and applying a synthesis transformation process to generate reconstructed image using the quantized latent samples ŷ.

An eighth aspect relates to an image encoding method, comprising: transforming an input image into latent samples y using an analysis transform; quantizing the latent samples y using a hyper encoder to generate quantized hyper latent samples \hat{z}; encoding the quantized hyper latent samples \hat{z} into a bitstream using entropy encoding; applying a latent sample prediction process to obtain quantized latent samples ŷ and quantized residual latent samples ŵ based on the latent samples y using the quantized hyper latent samples ŵ; obtaining prediction samples μ following the latent sample prediction process; and entropy encoding the quantized hyper latent samples \hat{z} and the quantized residual latent samples ŵ into the bitstream.

Optionally, in any of the preceding aspects, another implementation of the aspect provides that the header specifies a height of an original input picture in a number of luma samples before a resampling process (original_size_h) and a width of the original input picture in a number of luma samples before the resampling process (original_size_w).

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a typical transform coding scheme.

FIG. 2 illustrates an example of a quantized latent when hyper encoder/decoder are used.

FIG. 3 illustrates an example of a network architecture of an autoencoder implementing a hyperprior model.

FIG. 4 illustrates a combined model jointly optimizing an autoregressive component that estimates the probability distributions of latents from their causal context (i.e., context model) along with a hyperprior and the underlying autoencoder.

FIG. 5 illustrates an encoding process utilizing a hyper encoder and a hyper decoder.

FIG. 6 illustrates an example decoding process.

FIG. 7 illustrates an example implementation of encoding and decoding processes.

FIG. 8 illustrates a 2-dimensional forward wavelet transform.

FIG. 9 illustrates a possible splitting of the latent representation after the 2D forward transform.

FIGS. 10A-10B illustrate an example of the structure of the proposed decoder architecture.

FIGS. 11A-11B illustrates an example of the structure of the proposed encoder architecture.

FIG. 12 illustrates the details of the attention block, residual unit, and residual block.

FIG. 13 illustrates the details of the residual downsample block and residual upsample block.

FIG. 14 illustrates a utilized masked convolution kernel.

FIG. 15 illustrates a latent sample processing pattern according to wavefront parallel processing (WPP).

FIG. 16 illustrates an example of vertical tiling and horizontal tiling for the synthesis transform network.

FIG. 17 illustrates the structure of the discriminator.

FIG. 18 is a block diagram showing an example video processing system.

FIG. 19 is a block diagram of an example video processing apparatus.

FIG. 20 is a flowchart for an example method of video processing.

FIG. 21 is a block diagram that illustrates an example video coding system.

FIG. 22 is a block diagram that illustrates an example encoder.

FIG. 23 is a block diagram that illustrates an example decoder.

FIG. 24 is a schematic diagram of an example encoder.

FIG. 25 is an image decoding method according to an embodiment of the disclosure.

FIG. 26 is an image encoding method according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, the techniques described herein are applicable to other video codec protocols and designs.

### 1. Summary

A neural network based image and video compression method comprising an auto-regressive subnetwork and an entropy coding engine, wherein entropy coding is performed independently of the auto-regressive subnetwork.

### 1. Background

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half-decade. It is reported that the latest neural network-based image compression algorithm [1] achieves comparable rate distortion (R-D) performance with Versatile Video Coding (VVC) [2], the latest video coding standard developed by Joint Video Experts Team (JVET) with experts from Moving Picture Experts Group (MPEG) and Video Coding Experts Group (VCEG). With the performance of neural image compression continually being improved, neural network-based video compression has become an actively developing research area. However, neural network-based video coding still remains in its infancy due to the inherent difficulty of the problem.

2.1 Image/video compression.

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., discrete cosine transform (DCT) or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations International Telecommunication Union-Telecommunication (ITU-T) and International Organization for Standardization (ISO)/International Electrotechnical Commission (IEC) has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/High Efficiency Video Coding (HEVC). After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new technique since there were a number of researchers working on neural network-based image coding [3]. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks.

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression.

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling.

According to Shannon's information theory [6], the optimal method for lossless coding can reach the minimal coding rate—log₂p(x) where p(x) is the probability of symbol x. A number of lossless coding methods were developed in literature and among them arithmetic coding is believed to be among the optimal ones [7]. Given a probability distribution p(x), arithmetic coding ensures that the coding rate to be as close as possible to its theoretical limit—log₂p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red green blue (RGB) color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Most of the compression methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1 ,} … , {x}_{i - 1} , h ) \qquad ( 3 )$$

where h is the additional condition and p(x=p(h)p(x|h), meaning the modeling is split into an unconditional one and a conditional one. The additional condition can be image label information or high-level representations.

### 2.3.2 Auto-Encoder.

Auto-encoder originates from the well-known work proposed by Hinton and Salakhutdinov [17]. The method is trained for dimensionality reduction and includes two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

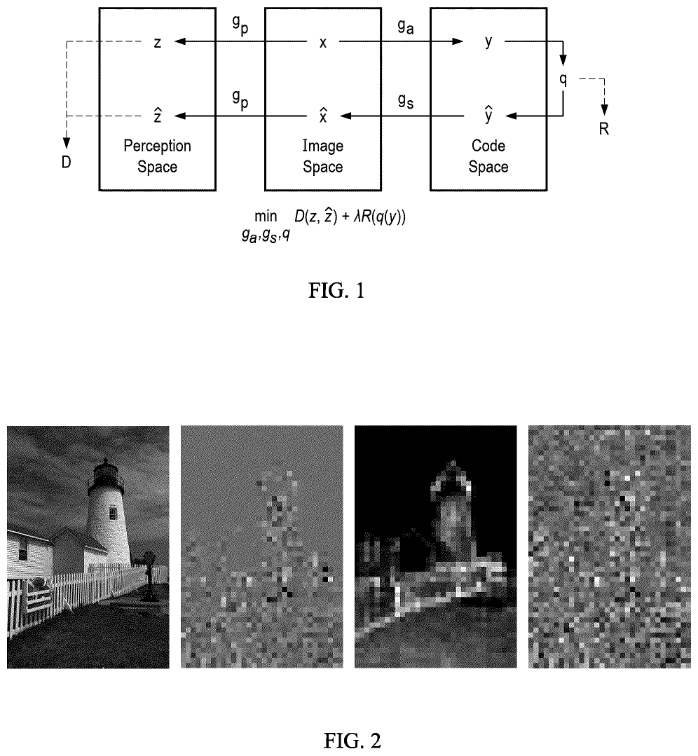

FIG. 1 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges. First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, recurrent neural networks (RNNs) and convolutional neural networks (CNNs) are the most widely used architectures. In the RNNs relevant category, Toderici et al. [18] propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. [19] then proposed an improved version by upgrading the encoder with a neural network similar to Pixel recurrent neural network (PixelRNN) to compress the binary codes. The performance is reportedly better than JPEG on Kodak image dataset using multi-scale structural similarity (MS-SSIM) evaluation metric. Johnston et al. [20] further improve the RNN-based solution by introducing hidden-state priming. In addition, an SSIM-weighted loss function is also designed, and spatially adaptive bitrates mechanism is enabled. They achieve better results than better portable graphics (BPG) on Kodak image dataset using MS-SSIM as evaluation metric. Covell et al. [21] support spatially adaptive bitrates by training stop-code tolerant RNNs.

Ballé et al. [22] proposes a general framework for rate-distortion optimized image compression. The use multiary quantization to generate integer codes and consider the rate during training, i.e. the loss is the joint rate-distortion cost, which can be mean square error (MSE) or others. They add random uniform noise to stimulate the quantization during training and use the differential entropy of the noisy codes as a proxy for the rate. They use generalized divisive normalization (GDN) as the network structure, which includes a linear mapping followed by a nonlinear parametric normalization. The effectiveness of GDN on image coding is verified in [23]. Ballé et al. [24] then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. [25] improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of peak signal to noise ratio (PSNR). D. Minnen et al. [26] further exploit the structures in the residue space by introducing an autoregressive model to estimate both the standard deviation and the mean. In the latest work [27], Z. Cheng et al. use Gaussian mixture model to further remove redundancy in the residue. The reported performance is on par with VVC [28] on the Kodak image set using PSNR as evaluation metric.

### 2.3.3 Hyper Prior Model.

In the transform coding approach to image compression, the encoder subnetwork (section 2.3.2) transforms the image vector x using a parametric analysis transform gₐ(x,Ø_{g}) into a latent representation y, which is then quantized to form ŷ. Because ŷ is discrete-valued, it can be losslessly compressed using entropy coding techniques such as arithmetic coding and transmitted as a sequence of bits.

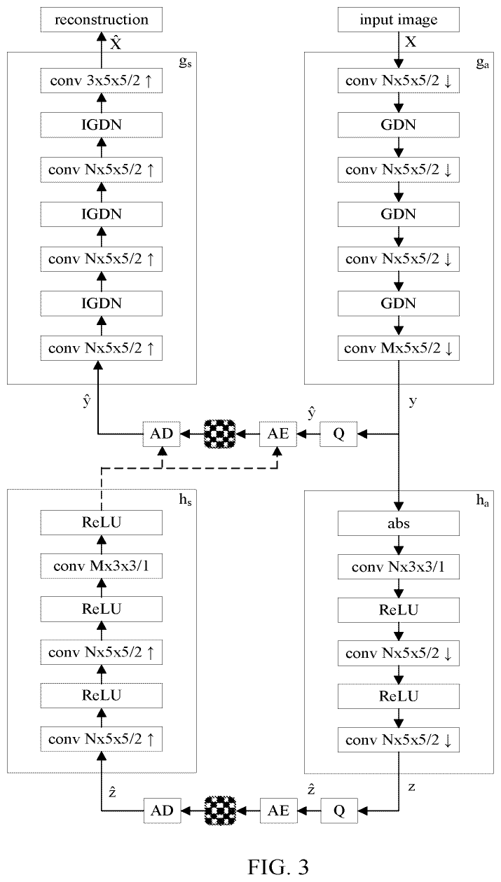

As evident from the middle left and middle right image of FIG. 2, there are significant spatial dependencies among the elements of ŷ. Notably, their scales (middle right image) appear to be coupled spatially. In [25] an additional set of random variables \hat{z} are introduced to capture the spatial dependencies and to further reduce the redundancies. In this case, the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2, an image from the Kodak dataset is shown on the left; the visualization of the latent representation y of that image is shown on the middle left; the standard deviations σ of the latent are shown on the middle right; and latents y after the hyper prior (hyper encoder and decoder) network are shown on the right.

FIG. 3 illustrates a network architecture of an autoencoder implementing the hyperprior model. The left side shows an image of an autoencoder network, the right side corresponds to the hyperprior subnetwork. The analysis and synthesis transforms are denoted as gₐ and gₛ, respectively. Q represents quantization, and AE, AD represent arithmetic encoder and arithmetic decoder, respectively. The hyperprior model includes two subnetworks, hyper encoder (denoted with ha) and hyper decoder (denoted with hs). The hyper prior model generates a quantized hyper latent (\hat{z}) which comprises information about the probability distribution of the samples of the quantized latent ŷ. \hat{z} is included in the bitstream and transmitted to the receiver (decoder) along with ŷ.

### 2.3.4 Context Model.

Although the hyperprior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to the process. For example, the context model subnetwork generates one sample of a latent, which is later used as input to obtain the next sample.

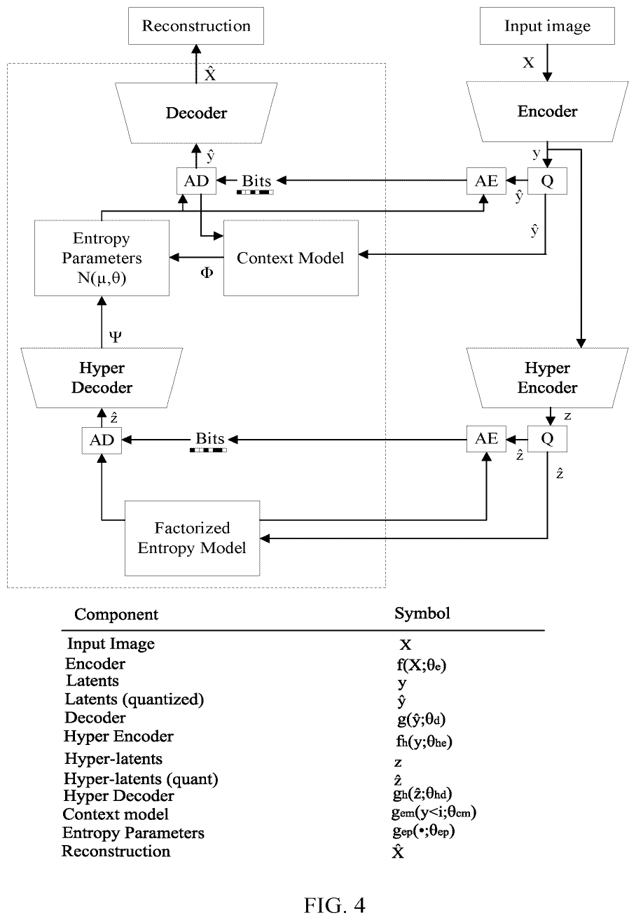

The authors in [26] utilize a joint architecture where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean u and scale (or variance) o parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). In [26] and according to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 The Encoding Process Using Joint Auto-Regressive Hyper Prior Model.

FIG. 4 corresponds to the state of the art compression method that is proposed in [26]. In this section and the next, the encoding and decoding processes will be described separately.

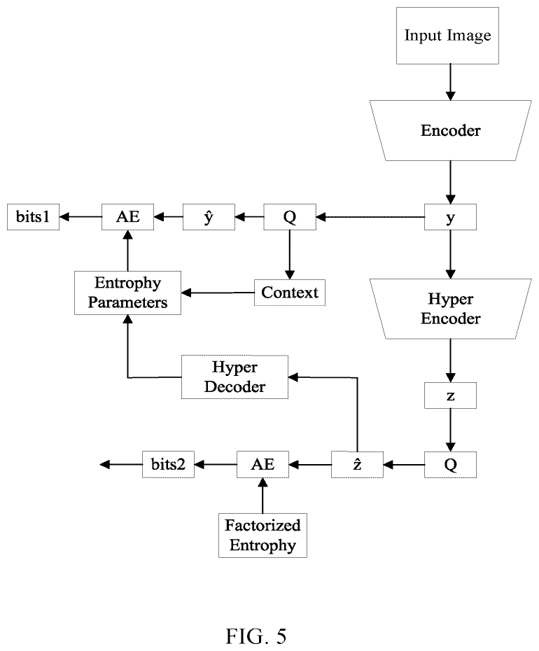

FIG. 5 illustrates the encoding process according to [26].

In FIG. 5, the encoding process is depicted. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. The latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In [26] the entropy parameters module are used to estimate the mean and the variance values.

The subnetwork hyper decoder generates part of the information used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process.

It is noted that the other names can be used for the modules described above.

In the above description, the all of the elements in FIG. 5 are collectively the encoder. The analysis transform that converts the input image into latent representation is also called an encoder (or auto-encoder).

### 2.3.6. The Decoding Process Using Joint Auto-Regressive Hyper Prior Model.

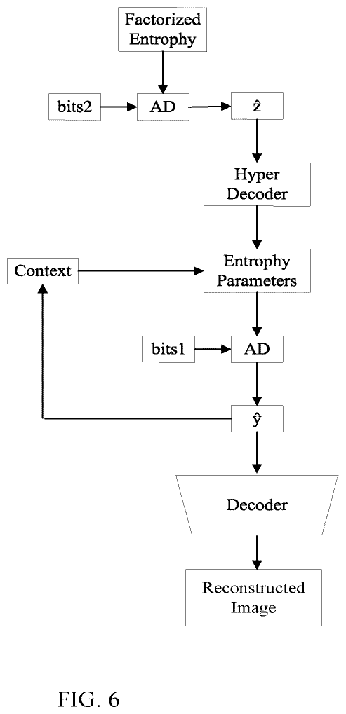

FIG. 6 illustrates the decoding process corresponding to [26]. FIG. 6 depicts the decoding process separately corresponding to [26].

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is 2, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.3.7. Wavelet Based Neural Compression Architecture.

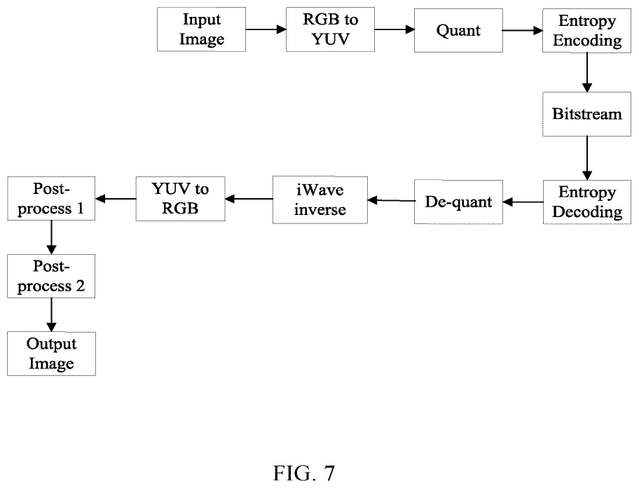

The analysis transform (denoted as encoder) in FIG. 5 and the synthesis transform (denoted as decoder) in FIG. 6 might be replaced by a wavelet based transform. FIG. 7 illustrates an example implementation of the wavelet based transform. In the figure, first the input image is converted from an RGB color format to a YUV color format. This conversion process is optional, and can be missing in other implementations. If however such a conversion is applied at the input image, a back conversion (from YUV to RGB) is also applied before the output image is generated. Moreover there are 2 additional post processing modules (post-process 1 and 2) shown in the figure. These modules are also optional, hence might be missing in other implementations. The core of an encoder with wavelet-based transform is composed of a wavelet-based forward transform, a quantization module and an entropy coding module. After these 3 modules are applied to the input image, the bitstream is generated. The core of the decoding process is composed of entropy decoding, de-quantization process and an inverse wavelet-based transform operation. The decoding process convers the bitstream into output image. The encoding and decoding processes are depicted below in FIG. 7.

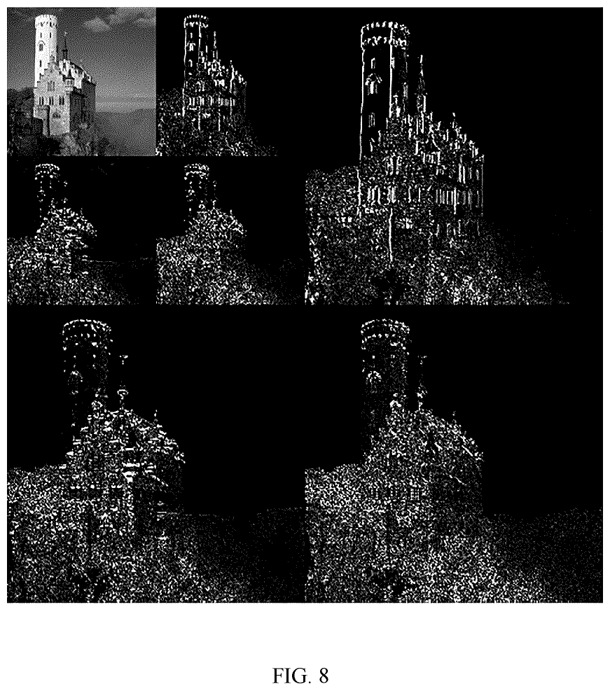

After the wavelet-based forward transform is applied to the input image, in the output of the wavelet-based forward transform the image is split into its frequency components. The output of a 2-dimensional (2D) forward wavelet transform (depicted as iWave forward module in the figure) might take the form depicted in FIG. 8. The input of the transform is an image of a castle. In the example, after the transform an output with 7 distinct regions are obtained. The number of distinct regions depend on the specific implementation of the transform and might different from 7. Potential number of regions are 4, 7, 10, 13, . . .

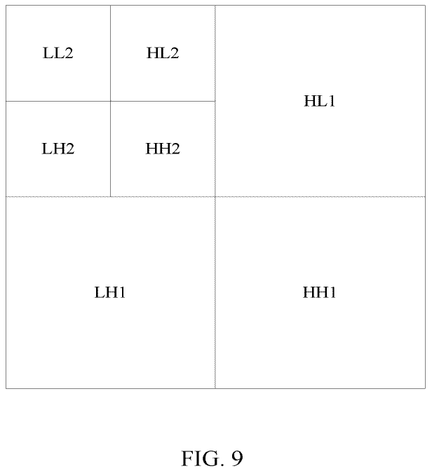

FIG. 9 illustrates a possible splitting of the latent representation after the 2D forward transform. The latent representation are the samples (latent samples, or quantized latent samples) that are obtained after the 2D forward transform. The latent samples are divided into 7 sections above, denoted as HH1, LH1, HL1, LL2, HL2, LH2 and HH2. The HH1 describes that the section comprises high frequency components in the vertical direction, high frequency components in the horizontal direction and that the splitting depth is 1. HL2 describes that the section comprises low frequency components in the vertical direction, high frequency components in the horizontal direction and that the splitting depth is 2.

After the latent samples are obtained at the encoder by the forward wavelet transform, they are transmitted to the decoder by using entropy coding. At the decoder, entropy decoding is applied to obtain the latent samples, which are then inverse transformed (by using iWave inverse module in FIG. 7) to obtain the reconstructed image.

### 2.4 Neural Networks for Video Compression.

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1 Low-Latency.

[29] are the first to propose a video compression scheme with trained neural networks. They first split the video sequence frames into blocks and each block will choose one from two available modes, either intra coding or inter coding. When intra coding is selected, there is an associated auto-encoder to compress the block. When inter coding is selected, motion estimation and compensation are performed with tradition methods and a trained neural network will be used for residue compression. The outputs of auto-encoders are directly quantized and coded by the Huffman method.

Chen et al. [31] propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme [34]. This scheme performs on par with H.264.

Lu et al. [32] propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. [33] propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in multi-scale structural similarity (MS-SSIM) than HEVC reference software.

J. Lin et al. [36] propose an extended end-to-end neural network-based video compression framework based on [32]. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than [32] and H.265 by a noticeable margin in terms of both peak signal-to-noise ratio (PSNR) and MS-SSIM.

Eirikur et al. [37] propose scale-space flow to replace commonly used optical flow by adding a scale parameter based on framework of [32]. It is reportedly achieving better performance than H.264.

Z. Hu et al. [38] propose a multi-resolution representation for optical flows based on [32]. Concretely, the motion estimation network produces multiple optical flows with different resolutions and let the network to learn which one to choose under the loss function. The performance is slightly improved compared with [32] and better than H.265.

### 2.4.2 Random Access.

Wu et al. [30] propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. [41] propose a method for interpolation-based video compression, wherein the interpolation model combines motion information compression and image synthesis, and the same auto-encoder is used for image and residual.

Amirhossein et al. [35] propose a neural network-based video compression method based on variational auto-encoders with a deterministic encoder. Concretely, the model includes an auto-encoder and an auto-regressive prior. Different from previous methods, this method accepts a group of pictures (GOP) as inputs and incorporates a three dimensional (3D) autoregressive prior by taking into account of the temporal correlation while coding the latent representations. It provides comparative performance as H.265.

### 2.5 Preliminaries.

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . ,255} is a common setting and in this case | [symbol] |=256=2⁸, thus the pixel can be represented by an 8-bit integer. An uncompressed grayscale digital imag has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={X₀, X₁, . . . , Xₜ, . . . , X_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Giga bits per second (Gbps), which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max ( [symbol] ) is the maximal value in [symbol] , e.g., 255 for 8-bit grayscale images. There are other quality evaluation metrics such as structural similarity (SSIM) and multi-scale SSIM (MS-SSIM) [4].

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate) [5]. There are other important aspects to evaluate image/video coding schemes, including encoding/decoding complexity, scalability, robustness, and so on.

### 3. The Present Disclosure

The detailed techniques herein should be considered as examples to explain general concepts. These techniques should not be interpreted in a narrow way. Furthermore, these techniques can be combined in any manner.

### 3.1 Network Architecture and Processing Steps.

### 3.1.1 Decoder.

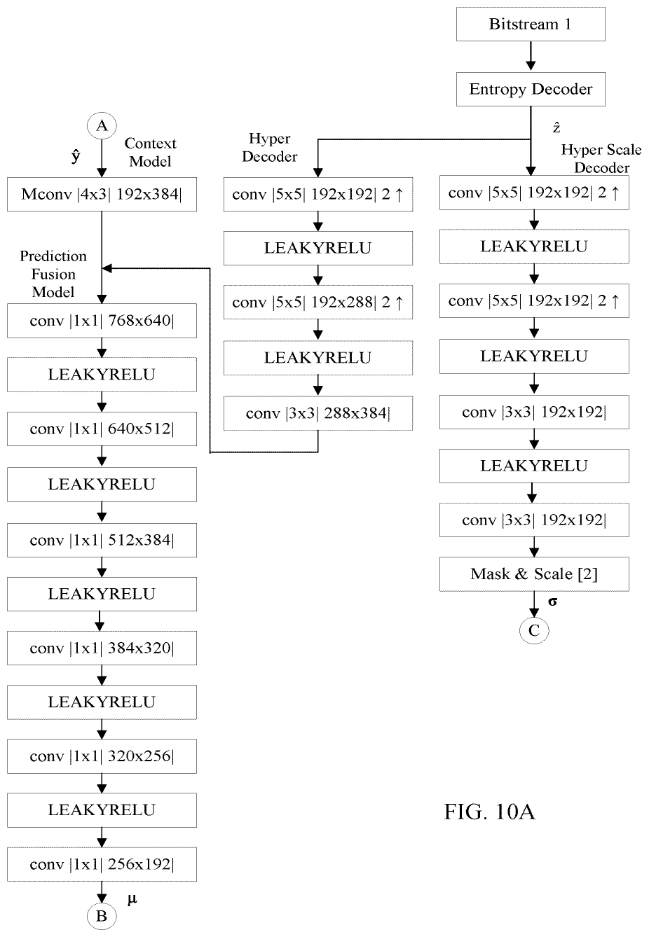

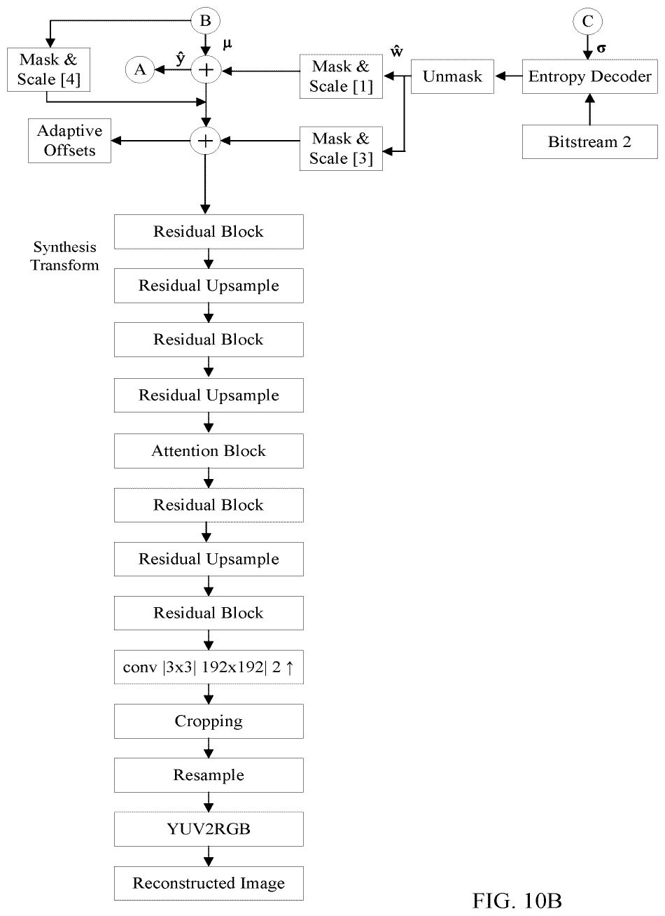

FIGS. 10A-10B illustrate an example of the structure of the proposed decoder architecture. The decoding process comprises three distinct steps, which are performed one after the other.

Firstly, the entropy decoding process is performed and completed to obtain quantized hyper latent \hat{z} and the quantized residual latent ŵ.

Secondly, the latent sample prediction process is applied and completed to obtain quantized latent samples ŷ from \hat{z} and ŵ.

Finally, the synthesis transformation process is applied to generate reconstructed image using ŷ.

### 3.1.2. Entropy Decoding Process.

The entropy decoding process comprises parsing two independent bitstreams that are packed into one single file. The first bitstream (Bitstream 1 in FIG. 10A), is decoded using a fixed probability density model. The discretized cumulative distribution function is stored in a predetermined fixed table and is used to parse the quantized hyper prior latent \hat{z}. The quantized hyper prior latent \hat{z} is then processed by the Hyper Scale Decoder, which is a NN based subnetwork that is used to generate gaussian variances σ. Afterwards the quantized residual latent samples ŵ are obtained by applying arithmetic decoding on the second bitstream (Bitstream 2), assuming the zero-mean gaussian distribution [symbol] (0, θ²).

The modules taking part in the entropy decoding process include the entropy decoders, the unmask, and the hyperscale decoder It is noted that the entire entropy decoding process can be performed before latent sample prediction process begins.

### 3.1.3 Latent Sample Prediction Process.

At the beginning of the latent sample prediction process, an inverse transform operation is performed on the hyper prior latent \hat{z} by the Hyper Scale Decoder. The output of this process is concatenated with the output of the Context Model module, which is then processed by the Prediction Fusion Model to generate the prediction samples μ. The prediction samples are then added to the quantized residual samples ŵ to obtain the quantized latent samples ŷ.

It is noted that the latent sample prediction process is an auto-regressive process. However, thanks to the proposed architectural design, quantized latent samples ŷ[:,i,j] in different rows can be processed in parallel.

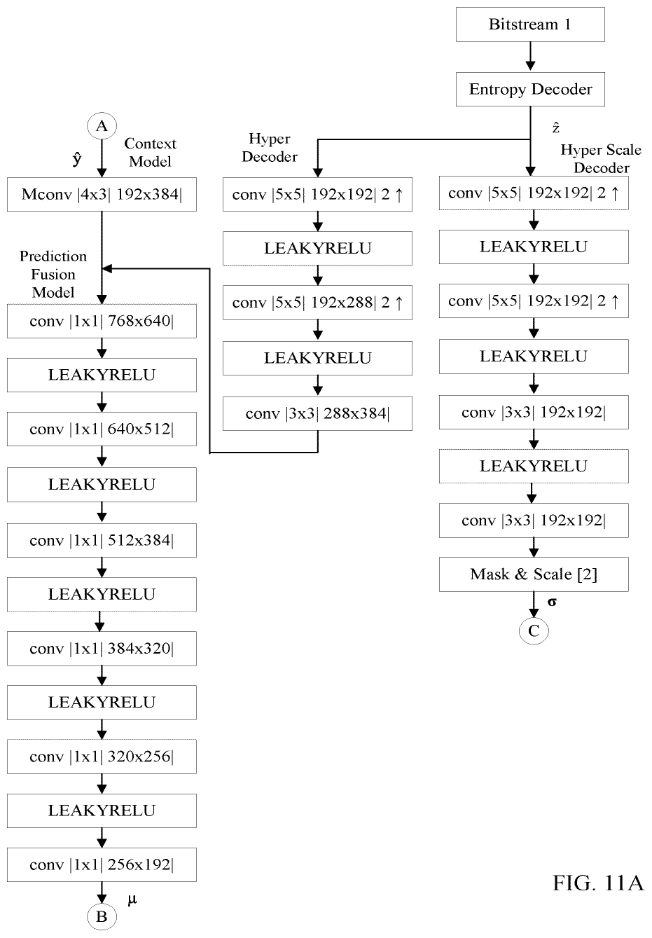

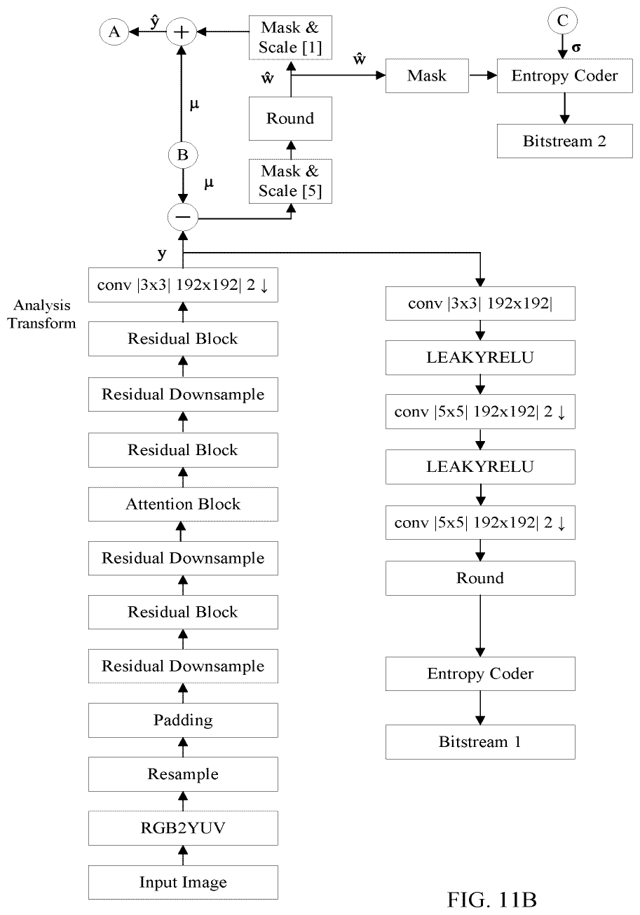

The modules taking part in the latent sample prediction process are marked with blue in FIG. 11.

### 3.1.4 Synthesis Transformation Process.

The synthesis transformation process is performed by the Synthesis Transform module in FIG. 11.

### 3.2 Encoder.

The encoding process comprises the analysis transformation, hyper analysis transformation, residual sample generation and entropy encoding steps. FIGS. 11A-11B illustrates an example of the structure of the proposed encoder architecture.

### 3.2.1 Analysis Transformation Process.

Analysis transform is the mirror of the synthesis transform as described in section 2.1.3. The input image is transformed using Analysis transform into latent samples y.

### 3.2.2 Hyper Analysis Transformation Process.

Hyper Encoder module is the mirror operation of the Hyper Decoder as described in section 2.1.2. the output of the hyper encoding process is rounded and included in Bitstream 1 via entropy coding.

### 3.2.3 Residual Sample Generation Process.

The residual sample generation process comprises the latent sample prediction process as described in section 2.1.2. After the sample prediction process is applied, prediction samples μ are obtained. Then prediction samples are subtracted from the latent samples y, to obtain the residual samples, which are rounded to obtain quantized residual samples ŵ.

### 3.2.4 Entropy Encoding Process.

The entropy encoding process is the mirror of the entropy decoding process as described in section 2.1.1. The quantized residual samples ŵ are entropy encoded using utilizing the gaussian variance variables σ that are obtained as output of the hyper scale decoder.

### 3.3 Sub-Networks.

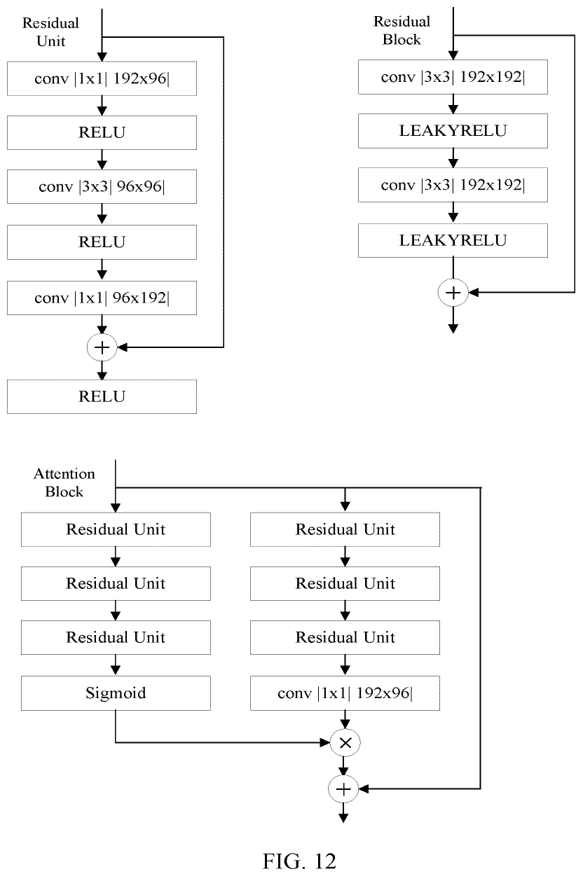

FIG. 12 illustrates the details of the attention block, residual unit, and residual block.

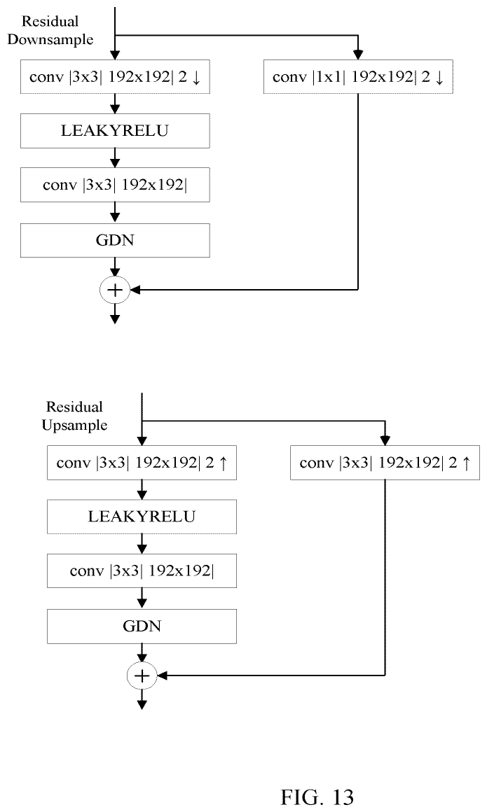

FIG. 13 illustrates the details of the residual downsample block and residual upsample block.

### 3.4 Description of Coding Tools.

### 3.4.1 Decoupled Entropy Decoding and Latent Sample Reconstruction (Decoupled Network).

The entropy decoding process employs arithmetic decoding, which is a process that is fully sequential with little possibility of parallelization. Although the bitstream can be split into multiple sub-bitstreams to improve parallel processing capability, this comes with the cost of coding loss, and still every bin in the sub-bitstream must be processed sequentially. Therefore, parsing of the bitstream is completely unsuitable for a processing unit that is capable of massive parallel processing (such as a graphics processing unit (GPU) or a neural processing unit (NPU)), which is the ultimate target of a future end-2-end image codec.

This issue has been already recognized in development of the state-of-the-art video coding standards such as HEVC and VVC. In such standards the parsing of the bitstream via the context-adaptive binary arithmetic coding (CABAC) engine is performed completely independently of sample reconstruction. This allows development of a dedicated engine for CABAC, which starts parsing of the bitstream in advance of starting the sample reconstruction. The bitstream parsing is the absolute bottleneck of the decoding process chain, and the design principle followed by HEVC and VVC allows that the CABAC can be performed without waiting any sample reconstruction process.

Though the above-mentioned parsing independency principle is a strictly followed in HEVC and VVC, state of the art end to end (E2E) image coding architectures that can achieve competitive coding gains suffer from very slow decoding times because of this issue. The architectures such as [3] employ auto-regressive processing units in the entropy coding unit, that renders them incompatible with massively parallel processing units and hence extremely slow decoding time.

One of core algorithms of our submission is the network architecture that enables parsing of the bitstream independently from latent sample reconstruction, which is called “Decoupled Network” for short. With the Decoupled Network, two hyper decoders are employed instead of a single one, named as hyper decoder and hyper scale decoder, respectively. The hyper scale decoder generates the gaussian variance parameters σ and is part of the entropy decoding process. The hyper decoder on the other hand is a part of the latent sample reconstruction process and takes part in generating the latent prediction samples μ. In the entropy decoding process, the quantized residual samples ŵ are decoded, using only σ. As a result, the entropy decoding process can be performed completely independently of the sample reconstruction process.

After the quantized residual samples ŵ are decoded from the bitstream, the latent sample reconstruction process is initiated with the inputs ŵ and \hat{z} that are completely available. The modules taking part in this process are hyper decoder, context model and the prediction fusion model, which are all NN units requiring massive amount of computation which can be conducted in parallel. Therefore, the latent sample prediction process is now suitable to be executed in a GPU-like processing unit, which provides huge advantage in implementation flexibility and huge gains in decoding speed.

### 3.4.2 Wavefront Parallel Processing (WPP).

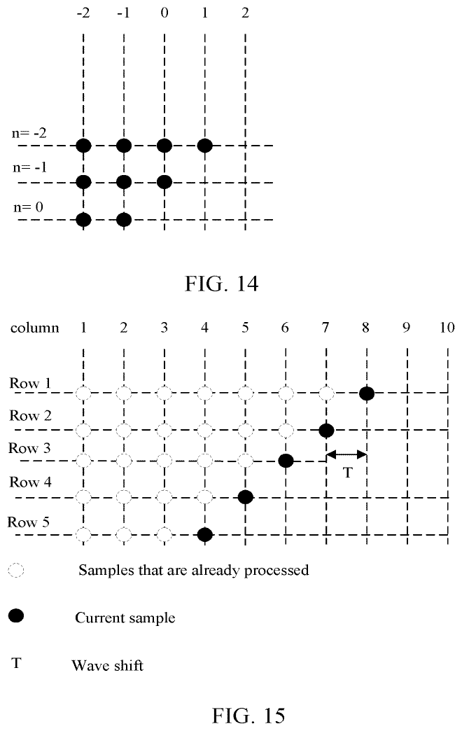

FIG. 14 illustrates a utilized masked convolution kernel. In the submissions the two dimensional (2D) masked convolution kernel as depicted in FIG. 14 is utilized.

In order to increase the utilization of the GPU a wavefront parallel processing mechanism is introduced in the latent sample prediction process. The kernel of the context model module is depicted in FIG. 14, where the sample to be predicted is catered at the 0,0 coordinate. The kernel is designed in such a way that a row of samples can be processed in parallel with the sample row above with a delay of just one sample. The sample processing pattern is depicted in FIG. 15.

### 3.4.3 Color Format Conversion.

In the encoding/decoding process, the proposed scheme supports 8-bit and 16-bit input images, and the decoded images can be saved in 8-bit or 16-bit. In the training process, the input images are converted to YUV space following BT. 709 specifications [5]. The training metric is calculated in YUV color space using weighted loss on luma and chroma components.

### 3.4.4 Adaptive Quantization (AQ).

In the Decoder the modules MASK & SCALE [1] and MASK & SCALE [2]. The operation includes the following steps:

1. A mask is determined for each sample latent sample using the formula:

$$mask [ c , i , j ] = \{ \begin{matrix}True & if σ [ c , i , j ] > thr AND greater\_flag equal to True \\ True & if σ [ c , i , j ] < thr AND greater\_flag equal to False \\ & False Otherwise\end{matrix}$$

2. Based on the value of the mask, a scaling operation is applied to the quantized residual samples and the gaussian variance samples:

$$MASK \& SCALE [ 1 ] : σ [ c , i , j ] = \{ \begin{matrix}σ [ c , i , j ] \times scale & if mask [ c , i , j ] is equal to True \\ σ [ c , i , j ] & otherwise\end{matrix}$$

$$MASK \& SCALE [ 2 ] : \hat{w} [ c , i , j ] = \{ \begin{matrix}\hat{w} [ c , i , j ] \times scale & if mask [ c , i , j ] is equal to True \\ \hat{w} [ c , i , j ] & otherwise\end{matrix}$$

In the Encoder additionally the module MASK & SCALE [5] participates in adaptive quantization and performs the additionally the following operation:

$$MASK \& SCALE [ 5 ] : w [ c , i , j ] = \{ \begin{matrix}w [ c , i , j ] / scale & if mask [ c , i , j ] is equal to True \\ w [ c , i , j ] & otherwise\end{matrix}$$

wherein w[c,i,j] is an unquantized residual latent sample, the “thr”, “scale” and “greater_flag” and parameters that are signaled in the bitstream as part of the adaptive masking and scaling syntax table (section 4.1). All 3 processing modules MASK & SCALE[1] MASK & SCALE[2] and MASK & SCALE[5] use the same mask.

The process of adaptive quantization can be performed multiple times one after the other to modify the ŵ and σ. In the bitstream the number of operations are signaled by num_adaptive_quant_params (Section 4.1). The value of this parameters is set to 3 by default and precalculated values of “thr”, “scale” and “greater_flag” are signaled in the bitstream for each process.

The adaptive quantization process controls the quantization step size of each residual latent sample according to its estimated variance σ.

### 3.4.5 Latent Scaling Before Synthesis (LSBS).

In the Decoder the modules MASK & SCALE [3] and MASK & SCALE [4] take part in this process and it is applied only at the decoder, the operation includes the following steps:

1. A mask is determined for each sample latent sample using the formula:

$$mask [ c , i , j ] = \{ \begin{matrix}True & if σ [ c , i , j ] > thr AND greater\_flag equal to True \\ True & if σ [ c , i , j ] < thr AND greater\_flag equal to False \\ & False Otherwise\end{matrix}$$

2. Based on the value of the mask, the value of the reconstructed latent samples are modified as follows:

$$\begin{matrix}MASK \& SCALE [ 3 ] \\ MASK \& SCALE [ 4 ]\end{matrix} : \hat{y} [ c , i , j ] = \begin{matrix}\hat{y} [ c , i , j ] + scale \times \hat{w} [ c , i , j ] + scale 2 \times μ [ c , i , j ] & if mask [ c , i , j ] == True \\ \hat{y} [ c , i , j ] & otherwise\end{matrix}$$

wherein the “thr”, “scale”, “scale2” and “greater_flag” and parameters that are signaled in the bitstream as part of the adaptive masking and scaling syntax table (section 4.1).

By default, 2 sets of LSBS parameter sets are signaled in the bitstream and are applied one after the other according to the order with which they are signaled. The number of LSBS parameters are controlled by the num_latent_post_process_params syntax element.

The signaling of adaptive quantization and latent scaling before synthesis use the same syntax table (section 4.1), the two processing modes are identified by the “mode” parameters. Additional “scale2” parameters is signaled got latent scaling before synthesis, when the mode parameters is set equal to 5.

### 3.4.6 Latent Domain Adaptive Offset (LDAO).

This process is applied right before the synthesis transform process. First for each of the 192 channels of the latent code a flag is signaled to indicate whether offsets are present or not (offsets_signalled [idx] flag as in section 4.2). Furthermore, the latent code is divided into tiles horizontally and vertically (the amount of vertical and horizontal splits are indicated by num_horizontal_split and num_vertical_split variables). Finally an offset value is signaled for each channel of each tile, if the offsets_signalled [idx] is true for that channel. The offset values are signaled using fixed length coding (8bits) and in absolute manner without predictive coding.

The LDAO tool helps counteracting the quantization noise introduced on the quantized latent samples. The offset values are calculated to minimize MSE (ŷ−y) by the encoder.

### 3.4.7 Block-Based Residual Skip.

A block-based residual skip mode is designed, in which the residuals are optionally encoded into the bitstreams, i.e. some of the residuals are skipped being encoded into the bitstreams. The residual maps are split into blocks. Depending on the statistics of the residual blocks, they are skipped if the percentage of zero entries is larger than a predefined threshold. This indicates that the residuals contain less information and skipping these residual blocks could achieve a better complexity-performance tradeoff.

### 3.4.8 Reconstruction Resampling.

Reconstruction resampling allows to select a model flexibly from a model set, while still achieving the target rate. In E2E based image coding, very annoying color artefacts can be introduced in the reconstructed image in the low-rate data points. In our solution if such an issue is identified, the input image is downsampled and a model designed for a higher rate is used to code the downsampled image. This effectively resolves the color shifting while trading with sample fidelity.

### 3.4.9 Quantization of Hyper Scale Decoder Network.

In arithmetic coding, the quantized latent feature is coded into the bitstream according to the probability obtained from the entropy model, and reconstructed from the bitstream through the inverse operation. In this case, even a minor change in the probability modeling will lead to quite different results, for this minor difference can be propagated in the following process and introduce undecodable issues in the final. To alleviate this issue and realize device interoperability in practical image compression, a neural network quantization strategy is proposed. Because of the Decoupled Entropy module, only scale information is needed when we perform arithmetic coding, which means we only need to quantize the Hyper Scale Decoder Network to ensure the multi-device consistency of the scale information inference. Two parameters, the scaling parameters and upper-bound parameters are stored along with the model weights. Scaling parameters scales the weights of the network and input values into a fixed precision and avoids the numerical overflow of the neural network computation, which is the main factor that affects the device interoperability. In our solution, the quantized weights and values are set to 16 bits, the scaling parameters are always the power of 2, and detailed values are depended on the potential max values of the weights and inputs that we observed in step 1. To further avoid the overflow of the calculation in middle network layers, upper-bound parameters are introduced to clip the value of each layer output.

It is needed to say that the quantization of the network and the quantized calculation are only performed after the model training. During the training phase, still floating precision is used to estimate the rate and realize the backpropagation of the neural network.

### 3.4.10 Tiling of Synthesis Transform.

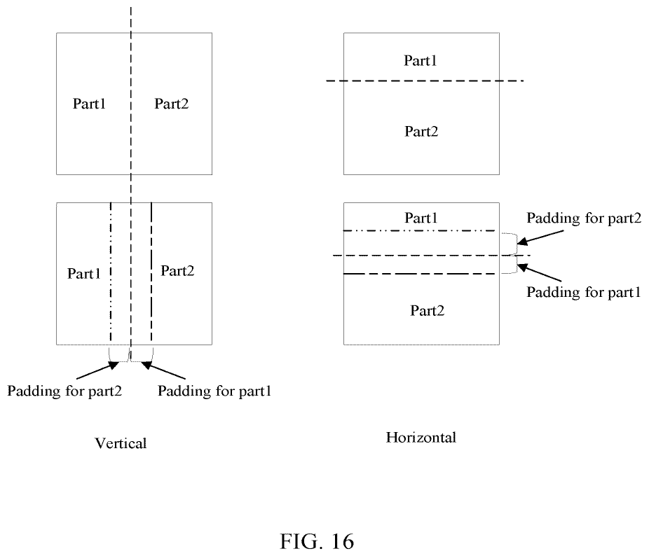

The spatial size of the feature maps increases significantly after feeding through the synthesis transform network. In the decoding process, out of memory issue happens when the image is oversized, or the decoder has a limited memory budget. To address this issue, we design a tiling partition for the synthesis neural network, which typically requires the most memory budget in the decoding process. As illustrated in the figure below, the feature maps are spatially partitioned into multiple parts. Each partitioned feature map will be fed through the following convolution layers one by one. After the most computationally intensive process is finished, they are cropped and stitched together to restore the spatial size. The partition type could be vertical, horizontal or any kinds of combinations of both, depending on the image size and the memory budget. To alleviate the potential reconstruction artifacts due to the boundary effects (typically caused by padding), there is a padding zone associated with each of the subpart. The padding zone is typically filled with the neighboring values in the feature maps. FIG. 16 illustrates an example of vertical tiling and horizontal tiling for the synthesis transform network.

### 3.4.11 Entropy Decoding.

Entropy decoding converts bitstreams into quantized features according to the probability table obtained from the entropy coding model. In our solution, only the gaussian variance parameters o that are obtained from samples of \hat{z} are needed to decode the bitstream and to generate the quantized residual latent samples w. Asymmetric numeral systems are used for symbol decoding.

### 3.5 High-Level Syntax.

| | Desc |
|---|---|
| model_id | u(8) |
| metric | u(8) |
| quality | u(8) |
| original_size_h | u(16) |
| original_size_w | u(16) |
| resized_size_h | u(16) |
| resized_size_w | u(16) |
| latent_code_shape_h | u(16) |
| latent_code_shape_w | u(16) |
| output_bit_depth | u(4) |
| output_bit_shift | u(4) |
| double_precision_processing_flag | u(1) |
| deterministic_processing_flag | u(1) |
| fast_resize_flag | u(1) |
| reserved_5_bits | u(5) |
| MaskScale( ) | |
| num_first_level_tile | u(8) |
| num_second_level_tile | u(8) |
| num_first_level_tile | u(8) |
| AdaptiveOffset( ) | |
| num_wavefront_min | u(8) |
| num_wavefront_max | u(8) |
| waveshift | u(8) |

### 3.5.1 Adaptive Masking and Scaling Syntax.

The syntax table depicted below comprises the parameters used in performing the Latent Scaling Before Synthesis (LSBS), Adaptive Quantization (AQ) and Block-based Residual Skip processes.

| | |
|---|---|
| MaskScale( ){ | |
| num_adaptive_quant_ params | u(8) |
| num_block_based_skip_params | u(8) |
| num_latent_post_process_params | u(8) |
| for( Idx = 0; Idx < num_adaptive_quant_ params + | |
| num_block_based_skip_params + | |
| num_latent_post_process_params; Idx ++ ) { | |
| filter[Idx][“mode”] | u(4) |
| filter[Idx][“block_size”] | u(1) |
| filter[Idx][“block_size”] += 1 | |
| filter[Idx][“greater_flag”] | u(1) |
| filter[Idx][“scale_precision”] | u(1) |
| filter[Idx][“thr_precision”] | u(1) |
| if (filter[Idx][“block_size”] > 0) | |
| filter[Idx][“block_size”] | u(8) |
| if (filter[Idx][“scale_precision”] == 1) | |
| filter[Idx][“scale”] | u(8) |
| else | |
| filter[Idx][“scale”] | u(16) |
| if (filter[Idx][“thr_precision”] == 1) | |
| filter[Idx][“thr”] | u(8) |
| else | |
| filter[Idx][“thr”] | u(16) |
| if (filter[Idx][“mode”] == 5) | |
| if (filter[Idx][“scale_precision”] == 1) | |
| filter[Idx][“scale2”] | u(8) |
| else | |
| filter[Idx][“scale2”] | u(16) |
| if (filter[Idx][“mode”] == 4){ | |
| filter[Idx][“num_channels”] | u(8) |
| for (filter[Idx][“num_channels”] == 1){ | |
| channel_num | u(8) |
| filter[Idx][channel_num] = True | |
| } | |
| } | |
| } | |
| } | |

### 3.5.2 Adaptive Offset Syntax.

The syntax table depicted below comprises the parameters used in performing the Latent Domain Adaptive Offset (LDAO) process.

| | |
|---|---|
| AdaptiveOffset( ){ | |
| adaptive_offset_enabled_flag | u(1) |
| reserved_7_bit | u(7) |
| if (adaptive_offset_enabled_flag){ | |
| num_horizontal_split | |
| num_vertical_split | |
| offsetPrecision | |
| for (idx = 0; idx<192;idx++) | |
| offsets_signalled[idx] | u(1) |
| for (idx = 0; idx<192;idx++) | |
| for (idx = 0; idx<192;idx++) | |
| for (idx = 0; idx<192;idx++) | |
| if (offsets_signalled [idx]){ | |
| offsets[idx][“value”] | u(7) |
| offsets[idx][“sign”] | u(1) |
| } | |
| } | |
| } | |

### 3.6 Encoder Algorithm.

All of the encoder config parameters that are required by the encoder are pre-optimized. The prepare_weights() function of the encoder calculates the default pre-optimized encoder config parameters and write_weights() function includes them in the high level syntax part of the bitstream.

Since no rate distortion optimization (RDO) is performed, the decoding process is not performed as part of encoding, and the encoding process is as fast as the decoding process. The encoding time is approximately just 1.6x of the decoding time using GPU processing.

In the submissions, some of the encoder config parameters that are required for encoding an image are slightly different from the default pre-optimized config parameters. This is because during the process of rate matching some parameters (such as the ones belonging to adaptive quantization) were modified for some images and rate points manually. Also in a very few cases manual parameter adjustment is applied to fix visual artefacts. If no rate matching needs to be applied, no recipes would be necessary for encoding process, the predefined default encoder config parameters are used by the encoder.

### 3.6.1 Online Latent Optimization Before Quantization.

In the encoder, after the analysis transform is applied and the unquantized latent samples y are obtained, one iteration of online refinement is applied. The y (not the quantized ŷ) inverse transformed using synthesis transform, and MSE loss is calculated using the reconstructed image. Using the MSE loss 1 iteration of backpropagation is applied to refine the samples of y. In other words, the online latent optimization includes only one forward and one backpropagation passes.

The online latent refinement is kept intentionally simple not to increase the encoding time. Furthermore only one iteration is applied tough increasing the number of iterations increase the gain, in order to limit the increase in encoding time.

### 3.7 Description of Training.

### 3.7.1 Objective Submission.

Training data. JPEG-AI suggested training set is used for the whole training process. In preparation of the training data, the original images are resized into multiple sizes, and randomly cropped into small training patches.

Training details. We train 16 models with different Lagrange multipliers. The training procedure is multi-stage. In the first stage, we train 5 models for 200 epochs. In the first training stage, a hyper scale decoder module that comprises 3 more additional layers are used. In the second stage, the longer hyper scale decoder network is replaced with the one depicted in FIG. 11 and the whole codec is trained for another 100 epochs. Finally in the third stage, we use the 5 trained models from stage 2 to obtain the other 11 models through finetuning. The initial learning rate for three stages are set to 1e-4, 1e-5 and 1e-5, respectively. Adam optimizer and reduce on plateau learning rate scheduler are used in the whole training process.

### 3.7.2 Subjective Submission.

To further improve the visual quality, we did an analysis of the relationship in rate, objective solution, and perceptual-based solution. For the low-rate model, we utilize additionally trained five perceptual-based models to improve the subjective quality at the corresponding rate point. Specifically, to obtain these perceptual-based models, we use corresponding objective-oriented models as the starting point and use a perceptual loss function to train five models at a low rate. The definition of perceptual loss is as follows:

$$L = \frac{5}{6} λ \cdot [ {255}^{2} \times ( \frac{3}{8} \times MSE + \frac{3}{4} \times 1 {0}^{- 4} \times {G}_{loss} + 5 \times 1 {0}^{- 3} \times LPIPS ) + 0.5 \times ( 1 - {Y}_{MSSSIM} ) ] + R ,$$

where Gₗₒₛₛ is the loss of the discriminator, LPIPS is Learned Perceptual Image Patch Similarity [4], and the setting of the λ is following the setting of the objective-oriented model.

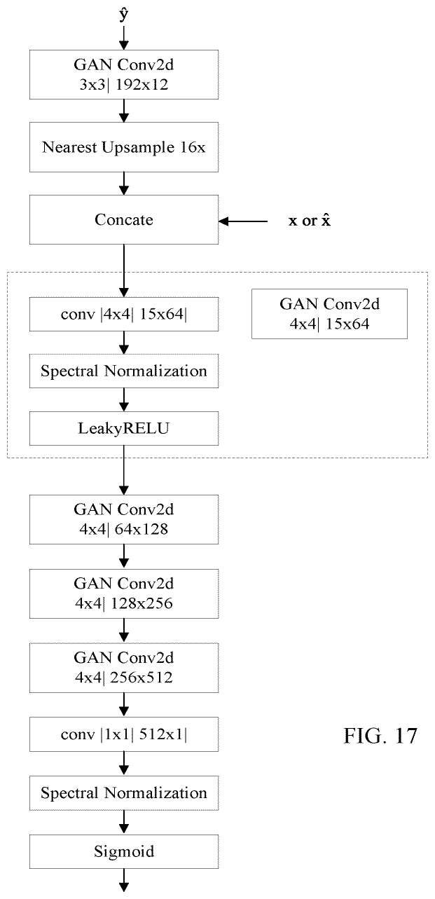

In the discriminator, we use ŷ as the conditional input, original YUV and reconstructed YUV will respectively be fed into the discriminator to test whether the input is real (original image) or fake (distorted image). Through the training process, our perceptual-based models will learn to recover images as closely as possible to the original image in visual quality. The structure of the discriminator is shown in FIG. 17.

It is noted that the discriminator is only utilized in the training process, and is not be included in the final model.

Further details regarding the referenced documents may be found in:
[1] Z. Cheng, H. Sun, M. Takeuchi and J. Katto, “Learned image compression with discretized gaussian mixture likelihoods and attention modules,” in Proceedings of the IEEE/CVF Conference on Computer Vision and Pattern Recognition, pp. 7939-7948, 2020.
[2] B. Bross, J. Chen, S. Liu and Y. -K. Wang, “Versatile Video Draft (Draft 10),” JVET-S2001, July 2020.
[3] R. D. Dony and S. Haykin, “Neural network approaches to image compression,” Proceedings of the IEEE, vol. 83, no. 2, pp. 288-303, 1995.
[4] Z. Wang, A. C. Bovik, H. R. Sheikh, and E. P. Simoncelli, “Image quality assessment: From error visibility to structural similarity,” IEEE Transactions on Image Processing, vol. 13, no. 4, pp. 600-612, 2004.
[5] G. Bjontegaard, “Calculation of average PSNR differences between RD-curves,” VCEG, Tech. Rep. VCEG-M33, 2001.
[6] C. E. Shannon, “A mathematical theory of communication,” Bell System Technical Journal, vol. 27, no. 3, pp. 379-423, 1948.
[17] G. E. Hinton and R. R. Salakhutdinov, “Reducing the dimensionality of data with neural networks,” Science, vol. 313, no. 5786, pp. 504-507, 2006.
[18] G. Toderici, S. M. O'Malley, S. J. Hwang, D. Vincent, D. Minnen, S. Baluja, M. Covell, and R. Sukthankar, “Variable rate image compression with recurrent neural networks,” arXiv preprint arXiv:1511.06085, 2015.
[19] G. Toderici, D. Vincent, N. Johnston, S. J. Hwang, D. Minnen, J. Shor, and M. Covell, “Full resolution image compression with recurrent neural networks,” in CVPR, 2017, pp. 5306-5314.
[20] N. Johnston, D. Vincent, D. Minnen, M. Covell, S. Singh, T. Chinen, S. Jin Hwang, J. Shor, and G. Toderici, “Improved lossy image compression with priming and spatially adaptive bit rates for recurrent networks,” in CVPR, 2018, pp. 4385-4393.
[21] M. Covell, N. Johnston, D. Minnen, S. J. Hwang, J. Shor, S. Singh, D. Vincent, and G. Toderici, “Target-quality image compression with recurrent, convolutional neural networks,” arXiv preprint arXiv:1705.06687, 2017.
[22] J. Ballé, V. Laparra, and E. P. Simoncelli, “End-to-end optimization of nonlinear transform codes for perceptual quality,” in PCS. IEEE, 2016, pp. 1-5.
[23] J. Ballé, “Efficient nonlinear transforms for lossy image compression,” in PCS, 2018, pp. 248-252.
[24] J. Ballé, V. Laparra and E. P. Simoncelli, “End-to-end optimized image compression,” in International Conference on Learning Representations, 2017.
[25] J. Ballé, D. Minnen, S. Singh, S. Hwang and N. Johnston, “Variational image compression with a scale hyperprior,” in International Conference on Learning Representations, 2018.
[26] D. Minnen, J. Ballé, G. Toderici, “Joint Autoregressive and Hierarchical Priors for Learned Image Compression”, arXiv.1809.02736. 1, 2, 3, 4, 7
[27] Z.Cheng, H. Sun M. Takeuchi and J. Katto, “Learned image compression with discretized Gaussian mixture likelihoods and attention modules,” in Proceedings of the IEEE/CVF Conference on Computer Vision and Pattern Recognition (CVPR), 2020.
[28] Github repository “CompressAI: https://github.com/InterDigitalInc/CompressAI,”, InterDigital Inc, accessed December 2020.
[29] T. Chen, H. Liu, Q. Shen, T. Yue, X. Cao, and Z. Ma, “DeepCoder: A deep neural network based video compression,” in VCIP. IEEE, 2017, pp. 1-4.
[30] C.-Y. Wu, N. Singhal, and P. Krahenbuhl, “Video compression through image interpolation,” in Proceedings of the European Conference on Computer Vision (ECCV), 2018, pp. 416-431.
[31] Z. Chen, T. He, X. Jin, and F. Wu, “Learning for video compression,” IEEE Transactions on Circuits and Systems for Video Technology, DOI: 10.1109/TCSVT.2019.2892608, 2019.
[32] G. Lu, W. Ouyang, D. Xu, X. Zhang, C. Cai, and Z. Gao, “DVC: An end-to-end deep video compression framework,” in Proceedings of the IEEE/CVF Conference on Computer Vision and Pattern Recognition (CVPR), 2019.
[33] O. Rippel, S. Nair, C. Lew, S. Branson, A. Anderson and L. Bourdev, “Learned Video Compression,” 2019 IEEE/CVF International Conference on Computer Vision (ICCV), Seoul, Korea (South), 2019, pp. 3453-3462, doi: 10.1109/ICCV.2019.00355.
[34] G. Toderici, D. Vincent, N. Johnston, S. J. Hwang, D. Minnen, J. Shor, and M. Covell, “Full resolution image compression with recurrent neural networks,” in CVPR, 2017, pp. 5306-5314.
[35] A. Habibian, T. Rozendaal, J. Tomczak and T. Cohen, “Video Compression with Rate-Distortion Autoencoders,” in Proceedings of the IEEE/CVF International Conference on Computer Vision (ICCV), 2019, pp. 7033-7042.
[36] J. Lin, D. Liu, H. Li and F. Wu, “M-LVC: Multiple frames prediction for learned video compression,” in Proceedings of the IEEE/CVF Conference on Computer Vision and Pattern Recognition (CVPR), 2020.
[37] E. Agustsson, D. Minnen, N. Johnston, J. Ballé, S. J. Hwang and G. Toderici, “Scale-Space Flow for End-to-End Optimized Video Compression,” 2020 IEEE/CVF Conference on Computer Vision and Pattern Recognition (CVPR), Seattle, WA, USA, 2020, pp. 8500-8509, doi: 10.1109/CVPR42600.2020.00853.
[38] X. Hu, Z. Chen, D. Xu, G. Lu, W. Ouyang and S. Gu, “Improving deep video compression by resolution-adaptive flow coding,” in European Conference on Computer Vision (ECCV) 2020.
[39] B. Li, H. Li, L. Li and J. Zhang, “A Domain Rate Control Algorithm for High Efficiency Video Coding,” in IEEE Transactions on Image Processing, vol. 23, no. 9, pp. 3841-3854 September 2014, doi: 10.1109/TIP.2014.2336550.
[40] L. Li, B. Li, H. Li and C. W. Chen, “A Domain Optimal Bit Allocation Algorithm for High Efficiency Video Coding,” in IEEE Transactions on Circuits and Systems for Video Technology, vol. 28, no. 1, pp. 130-142, January 2018, doi: 10.1109/TCSVT.2016.2598672.
[41] Abdelaziz Djelouah, Joaquim Campos, Simone Schaub-Meyer, and Christopher Schroers. Neural inter-frame com-pression for video coding. In ICCV, pages 6421-6429 October 2019.
[42] F. Bossen, Common Test Conditions and Software Reference Configurations, document Rec. JCTVC-J1100, Stockholm, Sweden, July 2012.

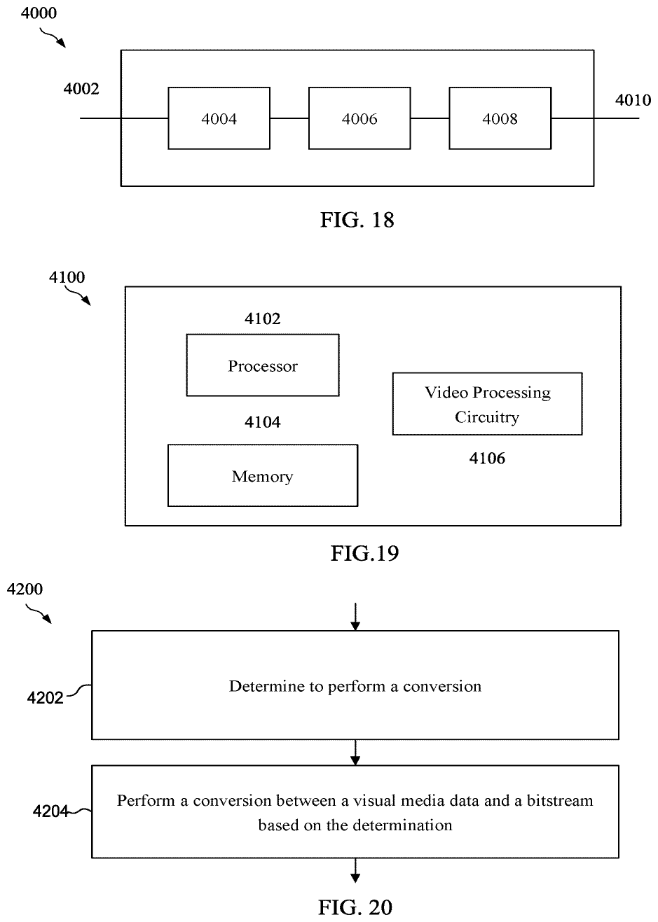

FIG. 18 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 19 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 20 is a flowchart for an example method 4200 of video processing. The method 4200 includes determining to apply a preprocessing function to visual media data as part of an image compression framework at step 4202. A conversion is performed between a visual media data and a bitstream based on the image compression framework at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

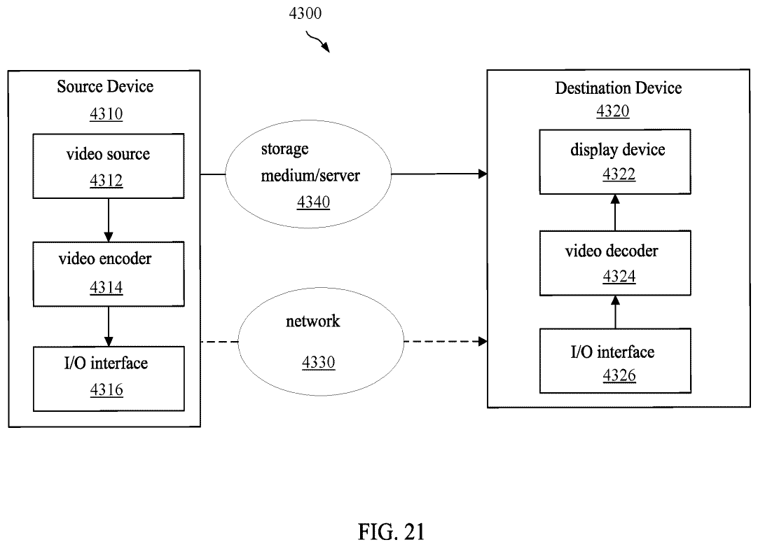

FIG. 21 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

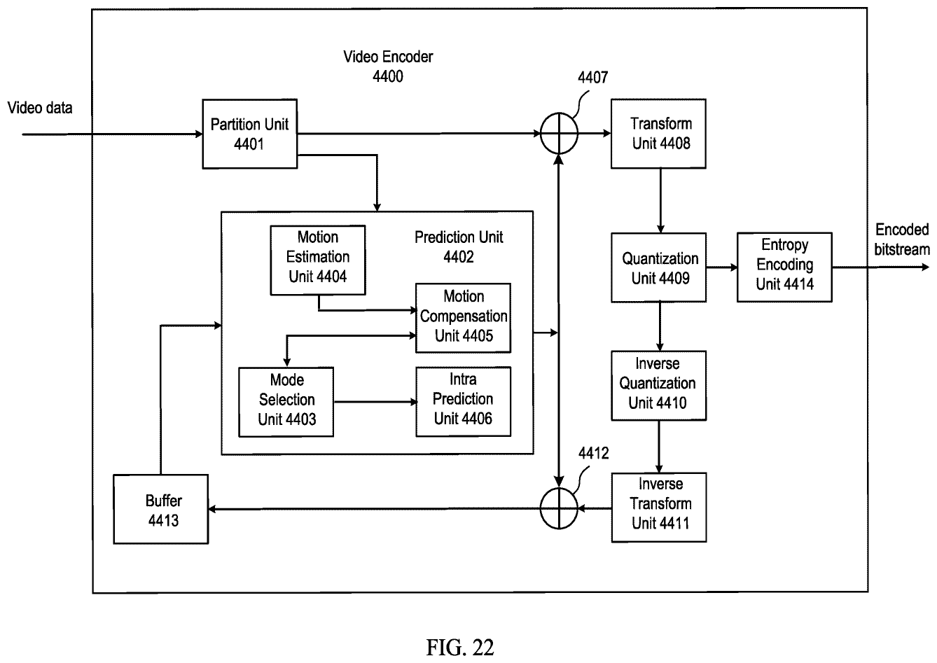

FIG. 22 is a block diagram illustrating an example of video encoder 4400, which may be video encoder 4314 in the system 4300 illustrated in FIG. 21. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

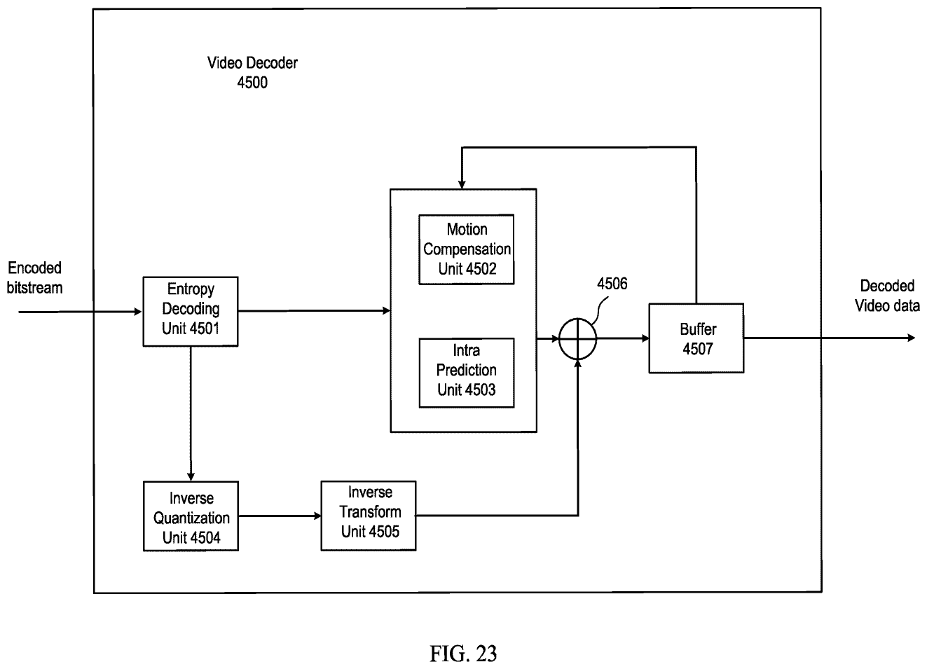

FIG. 23 is a block diagram illustrating an example of video decoder 4500 which may be video decoder 4324 in the system 4300 illustrated in FIG. 21. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

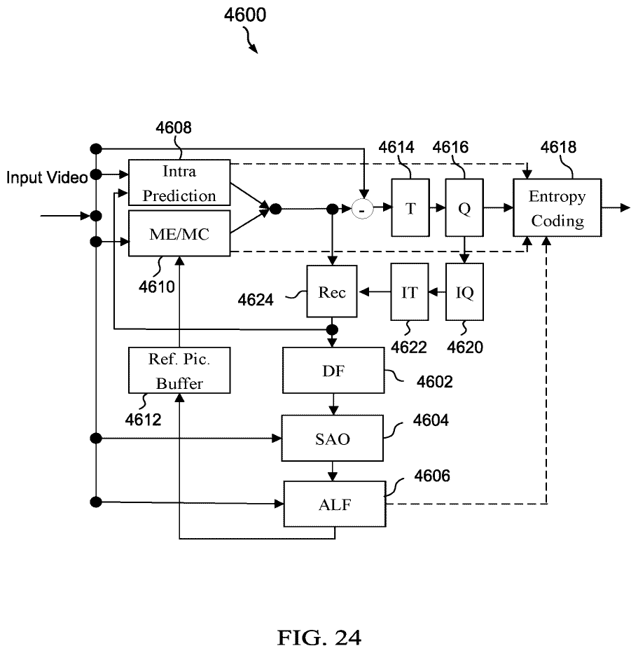

FIG. 24 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

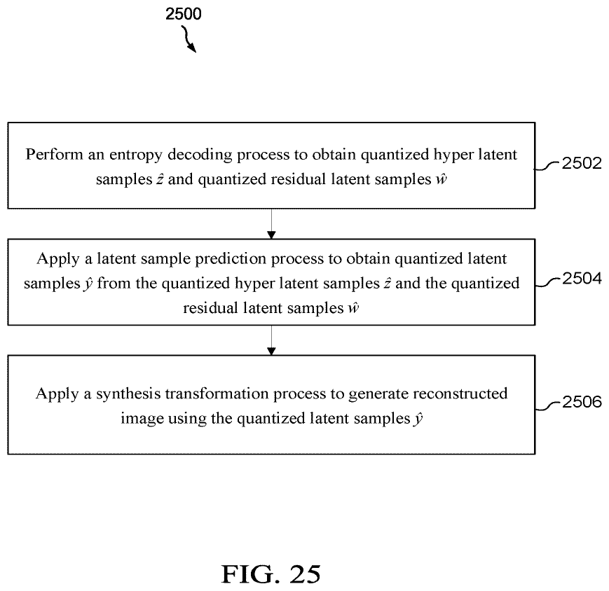

FIG. 25 is an image decoding method 2500 according to an embodiment of the disclosure. The method 2500 may be implemented by an decoding device (e.g., a decoder). In block 2502, the encoding device performs an entropy decoding process to obtain quantized hyper latent samples \hat{z} and quantized residual latent samples ŵ.

In block 2504, the encoding device applies a latent sample prediction process to obtain quantized latent samples ŷ from the quantized hyper latent samples \hat{z} and the quantized residual latent samples ŵ. In block 2506, the encoding device applying a synthesis transformation process to generate reconstructed image using the quantized latent samples ŷ.

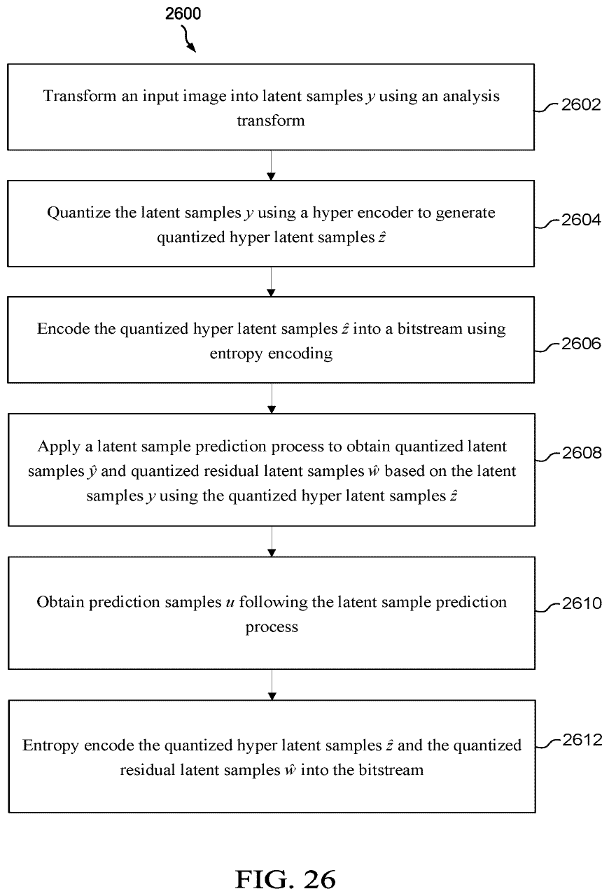

FIG. 26 is an image encoding method 2600 according to an embodiment of the disclosure. The method 2600 may be implemented by an encoding device (e.g., an encoder). In block 2602, the encoding device transforms an input image into latent samples y using an analysis transform.

In block 2604, the encoding device quantizes the latent samples y using a hyper encoder to generate quantized hyper latent samples \hat{z}. In block 2606, the encoding device encodes the quantized hyper latent samples \hat{z} into a bitstream using entropy encoding. In block 2608, the encoding device applies a latent sample prediction process to obtain quantized latent samples ŷ and quantized residual latent samples ŵ based on the latent samples y using the quantized hyper latent samples \hat{z}.

In block 2610, the encoding device obtains prediction samples μ following the latent sample prediction process. In block 2612, the encoding device entropy encodes the quantized hyper latent samples \hat{z} and the quantized residual samples ŵ into the bitstream.

A listing of solutions preferred by some examples is provided next.

The following solutions show examples of techniques discussed herein.

1. An image decoding method, comprising the steps of: obtaining, the reconstructed latents ŵ[:,:,:] using the arithmetic decoder; the reconstructed latents are fed into the synthesis neural network; based on the decoded parameters for tiled partitioning, at one or multiple locations, the output feature maps are tiled partitioned into multiple parts; each part is separately fed into the next stage of convolutional layers to obtain the output spatially partitioned feature maps; the spatially partitioned feature maps are cropped and stitched back to a whole feature map spatially; proceed until the image is reconstructed.

2. An image encoding method, comprising the steps of: obtain the quantized latents and tiled partitioning parameters; and encode the latents and partitioning parameters into the bitstreams.

3. An apparatus for processing video data comprising: a processor; and a non-transitory memory with instructions thereon, wherein the instructions upon execution by the processor, cause the processor to perform.

4. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-2.

5. A non-transitory computer-readable recording medium storing a bitstream of a video which is generated by a method performed by a video processing apparatus, wherein the method comprises the method of any of solutions 1-2.

6. A method for storing bitstream of a video comprising the method of any of solutions 1-2.

7. A method, apparatus, or system described in the present document.

Another listing of solutions preferred by some examples is provided next.

1. An image decoding method, comprising:
performing an entropy decoding process to obtain quantized hyper latent samples \hat{z} and quantized residual latent samples ŵ; applying a latent sample prediction process to obtain quantized latent samples ŷ from the quantized hyper latent samples \hat{z} and the quantized residual latent samples ŵ; and applying a synthesis transformation process to generate reconstructed image using the quantized latent samples ŷ.

2. The method of solution 1, wherein performing the entropy decoding process comprises parsing two independent bitstreams contained in a single file, and wherein a first of the two independent bitstreams is decoded using a fixed probability density model.

3. The method of solution 2, further comprising parsing the quantized hyper latent samples \hat{z} using a discretized cumulative distribution function, and processing the quantized hyper latent samples \hat{z} using a hyper scale decoder, which is a neural network (NN)-based subnetwork used to generate gaussian variances σ.

4. The method of solution 3, further comprising applying arithmetic decoding on a second of the two independent bitstreams to obtain the quantized residual latent samples ŵ, and assuming zero-mean gaussian distribution [symbol] (0,σ²).

5. The method of any of solutions 1-4, further comprising performing an inverse transform operation on the quantized hyper latent samples \hat{z}, and wherein the inverse transform operation is performed by the hyper scale decoder.

6. The method of any of solutions 1-5, wherein an output of the inverse transform operation is concatenated with an output of a context model module to generate a concatenated output, wherein the concatenated output is processed by a prediction fusion model to generate prediction samples μ, and wherein the prediction samples are added to the quantized residual latent samples ŵ to obtain the quantized latent samples ŷ.

7. The method of any of solutions 1-6, wherein the latent sample prediction process is an auto-regressive process.

8. The method of any of solutions 1-7, wherein the quantized latent samples ŷ[:,i,j] in different rows are processed in parallel.

9. An image encoding method, comprising: transforming an input image into latent samples y using an analysis transform; quantizing the latent samples y using a hyper encoder to generate quantized hyper latent samples \hat{z};encoding the quantized hyper latent samples \hat{z} into a bitstream using entropy encoding; applying a latent sample prediction process to obtain quantized latent samples ŷ and quantized residual latent samples ŵ based on the latent samples y using the quantized hyper latent samples \hat{z}; obtaining prediction samples μ following the latent sample prediction process; and entropy encoding the quantized hyper latent samples \hat{z} and the quantized residual latent samples ŵ into the bitstream.

10. The method of any of solutions 1-9, further comprising rounding an output of the hyper encoder.

11. The method of any of solutions 1-10, wherein the quantized residual latent samples ŵ are entropy encoded using gaussian variance variables σ obtained as output of a hyper scale decoder.

12. The method of any of solutions 1-11, wherein encoder configuration parameters are pre-optimized.

13. The method of any of solutions 1-12, wherein the method is implemented by an encoder, and wherein a prepare_weights() function of the encoder is configured to calculate default pre-optimized encoder configuration parameters.

14. The method of any of solutions 1-13, wherein a write_weights() function of the encoder includes the default pre-optimized encoder configuration parameters in high level syntax of a bitstream.

15. The method of any of solutions 1-14, wherein a rate distortion optimization process is not performed.

16. The method of any of solutions 1-15, wherein a decoding process is not performed as part of the image encoding method.

17. The method of any of solutions 1-16, comprising using a neural network-based adaptive image and video compression as disclosed herein.

18. An apparatus for processing video data comprising: a processor; and a non-transitory memory with instructions thereon, wherein the instructions upon execution by the processor, cause the processor to perform the method of any of solutions 1-17.

19. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-17.

20. A non-transitory computer-readable recording medium storing a bitstream of a video which is generated by a method performed by a video processing apparatus, wherein the method comprises the method of any of solutions 1-17.

21. A method for storing bitstream of a video comprising the method of any of solutions 1-17.

22. A method, apparatus, or system described in the present document.

In the solutions described herein, an encoder may conform to a format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The solutions listed in the present disclosure might be used for compressing an image, compressing a video, compression part of an image or compressing part of a video.

In addition, techniques, systems, subsystems, and methods described and illustrated in the various embodiments might be used for compressing an image, compressing a video, compression part of an image or compressing part of a video.

What is claimed is:

1. A method for visual data processing, comprising:
obtaining, for a conversion between a current visual data unit of visual data and a bitstream of the current visual data unit, first syntax information corresponding to adaptive masking and scaling and/or second syntax information corresponding to an adaptive offset process; and
performing the conversion based on the first syntax information and/or the second syntax information by applying neural network-based module processing.

2. The method of claim 1, wherein for the current visual data unit, quantized latent samples ŷ are obtained based on quantized hyper latent samples \hat{z} and quantized residual latent samples ŵ, and
wherein the quantized residual latent samples ŵ are determined based on the first syntax information and parameter information derived based on the quantized hyper latent samples ŵ.

3. The method of claim 1, wherein the first syntax information is used in performing an adaptive quantization process,
wherein the first syntax information includes a first syntax element included in the bitstream for specifying a number of filters used in the adaptive quantization process, and
wherein the first syntax element is coded with 8 bits.

4. The method of claim 1, wherein the first syntax information is used in performing a block-based skipping process,
wherein the first syntax information includes a second syntax element included in the bitstream for specifying a number of filters used in the block-based skipping process, and
wherein the second syntax element is coded with 8 bits.

5. The method of claim 1, wherein the first syntax information is used in performing latent domain masking and scaling,
wherein the first syntax information includes a third syntax element included in the bitstream for specifying a number of filters used in the latent domain masking and scaling, and
wherein the third syntax element is coded with 8 bits.

6. The method of claim 1, wherein the first syntax information includes a list of flags included in the bitstream, and
wherein the list of flags is used to indicate a three dimensional array specifying parameters for the adaptive masking and scaling.

7. The method of claim 1, wherein the second syntax information includes a fourth syntax element included in the bitstream for specifying whether the adaptive offset process is used for the current visual data unit, and w
herein the fourth syntax element is coded with one bit.

8. The method of claim 1, wherein the second syntax information includes a fifth syntax element included in the bitstream for specifying a number of bits reserved for the adaptive offset process, and
wherein the fifth syntax element is coded with 7 bits.

9. The method of claim 1, wherein the second syntax information includes a sixth syntax element included in the bitstream for specifying a number of horizontal splits in the adaptive offset process, and a seventh syntax element included in the bitstream for specifying a number of vertical splits in the adaptive offset process, and
wherein the sixth syntax element and the seventh syntax element are coded with 8 bits.

10. The method of claim 1, wherein the second syntax information includes an eighth syntax element included in the bitstream for specifying an offset precision value for processing an adaptive offset coefficient in the adaptive offset process.

11. The method of claim 1, wherein the second syntax information includes a list of binary flags included in the bitstream for specifying whether offset coefficients are signalled for 192 channels, and further includes a list of parameters corresponding to the offset coefficients for the 192 channels.

12. The method of claim 1, wherein a first flag is included in a picture header of the bitstream to specify an index of a coding model used in the conversion,
wherein a second flag is included in the picture header of the bitstream to specify metrics for training the coding model used in the conversion,
wherein a third flag is included in the picture header of the bitstream to specify a pretrained model quality of the coding model used in the conversion, and
wherein the first flag, the second flag, and the third flag are coded with 8 bits.

13. The method of claim 1, wherein a fourth flag is included in a picture header of the bitstream to specify a height of a quantized residual latent code for the current visual data unit,
wherein a fifth flag is included in the picture header of the bitstream to specify a width of the quantized residual latent code for the current visual data unit, and
wherein the fourth flag and the fifth flag are coded with 16 bits.

14. The method of claim 1, wherein a sixth flag is included in a picture header of the bitstream to specify a bit depth for output reconstruction corresponding to the current visual data unit,
wherein a seventh flag is included in the picture header of the bitstream to specify a number of bits needed to be shifted for the output reconstruction, and
wherein the sixth flag and the seventh flag are coded with 4 bits.

15. The method of claim 1, wherein an eighth flag is included in a picture header of the bitstream to specify whether to enable double precision processing for the current visual data unit,
wherein a ninth flag is included in the picture header of the bitstream to indicate a specified value for deterministic processing in the conversion,
wherein a tenth flag is included in the picture header of the bitstream to specify whether to use fast resizing for the current visual data unit, and
wherein the eighth flag, the ninth flag and the tenth flag are coded with one bit.

16. The method of claim 1, wherein a first indication is included in a picture header of the bitstream to specify a minimal number of threads used in wavefront processing for the current visual data unit,
wherein a second indication is included in the picture header of the bitstream to specify a maximum number of threads used in the wavefront processing for the current visual data unit,
wherein a third indication is included in the picture header of the bitstream to specify a number of pixels shifted in each row compared to a preceding row in the wavefront processing, and
wherein the first indication, the second indication, and the third indication are coded with 8 bits.

17. The method of claim 1, wherein the conversion includes encoding the current visual data unit into the bitstream.

18. The method of claim 1, wherein the conversion includes decoding the current visual data unit from the bitstream.

19. An apparatus for processing visual data comprising a processor and a non-transitory memory with instructions thereon, wherein the instructions upon execution by the processor, cause the processor to:
obtain, for a conversion between a current visual data unit of visual data and a bitstream of the current visual data unit, first syntax information corresponding to adaptive masking and scaling and/or second syntax information corresponding to an adaptive offset process; and
perform the conversion based on the first syntax information and/or the second syntax information by applying neural network-based module processing.

20. A non-transitory computer-readable storage medium storing instructions that cause a processor to:
obtain, for a conversion between a current visual data unit of visual data and a bitstream of the current visual data unit, first syntax information corresponding to adaptive masking and scaling and/or second syntax information corresponding to an adaptive offset process; and
perform the conversion based on the first syntax information and/or the second syntax information by applying neural network-based module processing.
